(19) United States
(12) Patent Application Publication
(10) Pub. No.: US 2014/0244936 A1
(43) Pub. Date: Aug. 28, 2014

(54) MAINTAINING CACHE COHERENCY BETWEEN STORAGE CONTROLLERS

(71) Applicant: LSI CORPORATION, San Jose, CA (US)

(72) Inventors: Parag R. Maharana, Fremont, CA (US); Pradeep R. Venkatesha, Bangalore (IN); Nagesh B. Kollipara, Bangalore (IN); Subburaj Ramasamy, Bangalore (IN); Nithin Surendran, Bangalore (IN)

(73) Assignee: LSI CORPORATION, San Jose, CA (US)

(21) Appl. No.: 13/970,025

(22) Filed: Aug. 19, 2013

(30) Foreign Application Priority Data
Feb. 25, 2013 (IN) 819CHE2013

(51) Int. Cl. G06F 12/08; G06F 12/12

(52) U.S. Cl. CPC G06F 12/0808; G06F 12/128
USPC 711/135; 711/133

(57) ABSTRACT

Systems and methods maintain cache coherency between storage controllers utilizing bitmap data. In one embodiment, a storage controller processes an I/O request for a logical volume from a host, and generates one or more cache entries in a cache memory that is based on the request. The storage controller identifies a backup storage controller for managing the logical volume, and generates bitmap data that identifies cache entries in the cache memory that have changed since synchronizing with the backup storage controller. The storage controller provides the bitmap data to the backup storage controller to allow the backup storage controller to synchronize its cache memory with the cache memory of the storage controller based on the bitmap data.

### CROSS REFERENCE TO RELATED APPLICATIONS

This document claims priority to Indian Patent Application Number 819/CHE/2013 filed on Feb. 25, 2013 (entitled MAINTAINING CACHE COHERENCY BETWEEN STORAGE CONTROLLERS) which is hereby incorporated by reference

### FIELD OF THE INVENTION

The invention generally relates to the field of data storage systems.

### BACKGROUND

In high performance/high reliability storage systems, dual storage controllers are utilized to manage I/O requests directed to logical volumes. The dual controllers are operated in an active mode on different logical volumes. The controller that owns a logical volume is considered as an active controller for the volume, while other controller serves as a backup controller for the volume. One controller may act as active and backup controller at same time on different logical volumes.

Cache memory is used by the controllers to improve the speed at which I/O requests for the volumes are processed. For example, in a write through cache, a write request is processed by the controller by storing the write data on the storage devices and in a cache memory of the storage controller. Subsequent requests for the data by the host system may then be read from the cache memory rather than the storage devices, which is faster. If the caches of the controllers are not synchronized, then the integrity of the storage system may be compromised if one controller operates on the logical volume of the other controller with incorrect data.

### SUMMARY

Systems and methods presented herein provide for maintaining cache coherency between storage controllers utilizing bitmap data. In one embodiment, a storage controller processes an I/O request for a logical volume from a host, and generates one or more cache entries in a cache memory that is based on the request. The storage controller identifies a backup storage controller for managing the logical volume, and generates bitmap data that identifies cache entries in the cache memory that have changed since synchronizing with the backup storage controller. The storage controller provides the bitmap data to the backup storage controller to allow the backup storage controller to synchronize its cache memory with the cache memory of the storage controller based on the bitmap data.

The various embodiments disclosed herein may be implemented in a variety of ways as a matter of design choice. For example, the embodiments may take the form of computer hardware, software, firmware, or combinations thereof. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of a storage system in an exemplary embodiment.

FIG. 2 is a flowchart illustrating a method of maintaining cache coherency between storage controllers utilizing bitmap data in an exemplary embodiment.

FIG. 3 is a block diagram of a plurality of cache entries in a cache memory of a storage controller in an exemplary embodiment.

FIG. 4 is a block diagram of bitmap data in an exemplary embodiment.

FIG. 5 is a flowchart illustrating a method of exchanging ownership of a logical volume in an exemplary embodiment.

FIG. 6 illustrates a computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

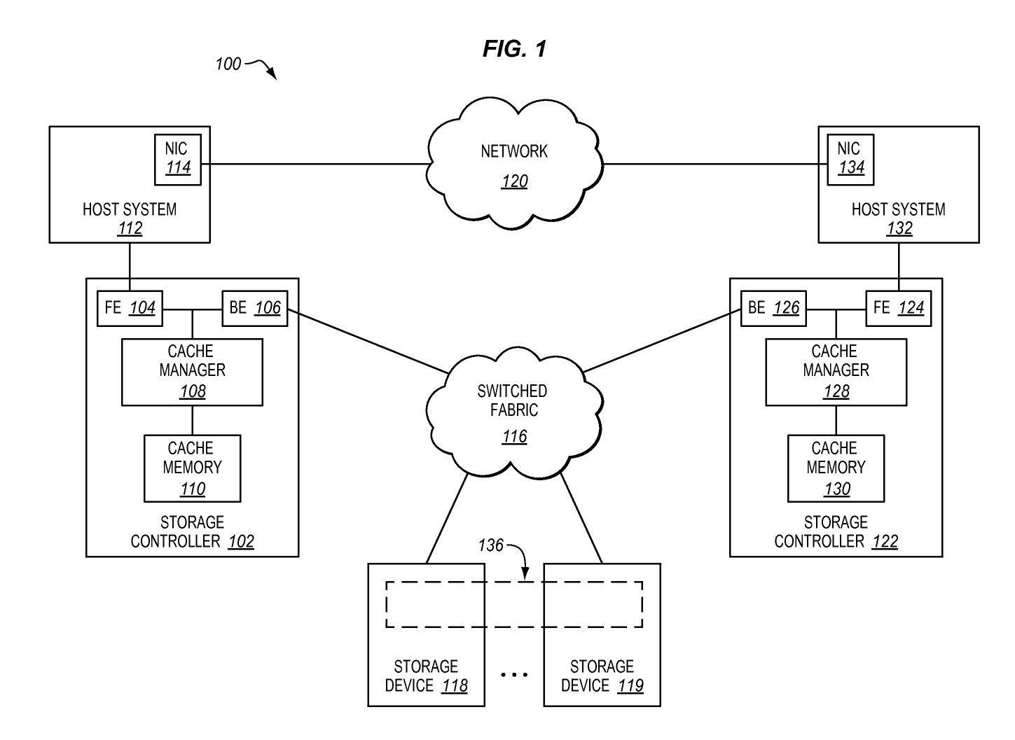

FIG. 1 is a block diagram of a storage system 100 in an exemplary embodiment. In this embodiment, storage system 100 includes a storage controller 102. Storage controller 102 is any suitable device that is operable to manage a logical volume provisioned at one or more storage devices. For example, storage controller 102 may comprise a Serial Attached Small Computer System Interface (SAS) compliant Host Bus Adapter (HBA). The HBA may manage multiple SAS or Serial Advanced Technology Attachment (SATA) storage devices that implement a Redundant Array of Independent Disks (RAID) logical volume. In this embodiment, storage controller 102 manages logical volume 136 that is provisioned on one or more storage devices 118-119. Storage controller 102 is coupled with storage devices 118-119 through switched fabric 116. Switched fabric 116 may include a SAS fabric, a Fibre channel fabric, etc.

Storage controller 102 of FIG. 1 has been enhanced to ensure that its cache memory 110 can be synchronized with one or more backup storage controllers (e.g., storage controller 122) utilizing bitmap data exchanges. In contrast to merely mirroring cache contents across a high speed dedicated communication channel, the bitmap data exchanges may be implemented across other communication paths, such as the Internet, Ethernet, etc. This allows for the implementation of redundant storage network configurations that were not previously possible. For example, when storage controllers reside within different host systems, bitmap data may be exchanged over other network paths to ensure that cache coherency may be maintained between controllers even though a dedicated high speed cache mirror channel is not available.

Referring again to FIG. 1, storage controller 102 includes a front-end interface 104, a back-end interface 106, and a cache memory 110. Front-end interface 104 receives Input/Output (I/O) requests from host system 112 for processing by storage controller 102. The I/O requests received from host system 112 are typically translated by storage controller 102 into one or more commands for accessing a logical volume, such as logical volume 136. For example, storage controller 102 may generate multiple RAID commands based on a single I/O request from host system 112. Back-end interface 106 enables communication between controller 102 and one or more storage devices 118-119 via switched fabric 116.

Cache memory 110 of storage controller 102 comprises any system, component, or device that is able to store data for high speed access. Some examples of cache memory 110 include, Random Access Memory, Non-Volatile (e.g., flash) memory, etc. Generally, cache memory 110 stores data related to I/O requests issued by host system 112 for logical volumes managed by storage controller 102. For example, host system 112 may issue a request to storage controller 102 to write data to logical volume 136. In response, storage controller 102 generates one or more commands to persistently store the data from the write request to logical volume 136. In addition, storage controller 102 may write a copy of the data and/or other portions of the write request to cache memory 110. Storage controller 102 may then respond to subsequent read requests for the data utilizing the information stored in cache memory 110, which is faster than reading the information from storage devices 118-119.

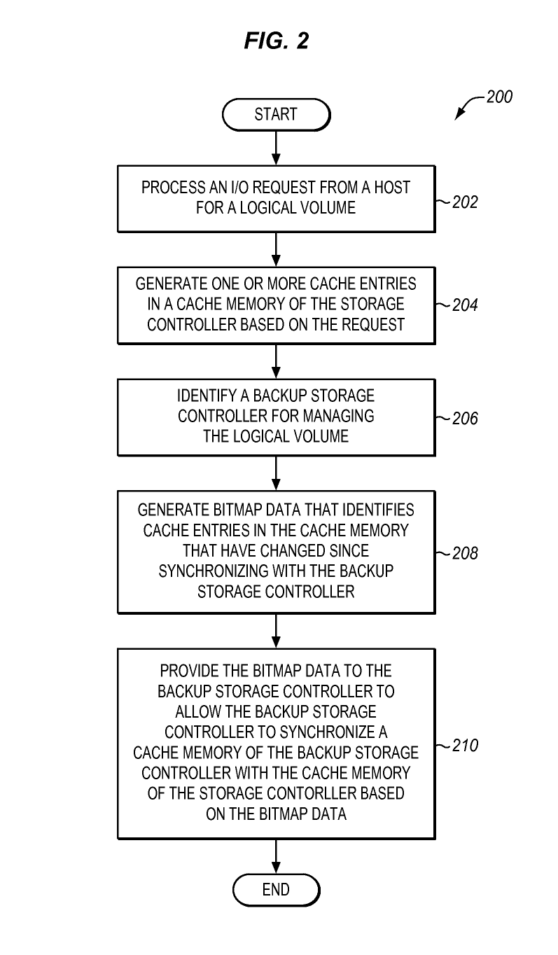

In this embodiment, storage controller 102 also includes a cache manager 108. Cache manager 108 comprises any system, component, or device that is able to utilize bitmap data to ensure that cache memory 110 may be synchronized with the cache memories of other storage controllers, such as cache memory 130 of storage controller 122. The particulars of how storage controller 102 has been enhanced in this regard will be discussed in more detail later on with regard to FIG. 2.

In storage system 100, multiple storage controllers may have access to storage devices 118-119 via switched fabric 116. For instance, storage controller 122 may actively manage other logical volumes (not shown) that are provisioned at storage devices 118-119, and/or may act as a backup storage controller to logical volume 136 in the event that storage controller 102 fails or otherwise becomes unavailable to manage logical volume 136. In this embodiment, storage controller 122 includes a front-end interface 124, a back-end interface 126, a cache manager 128, and a cache memory 130, which have been described previously with respect to storage controller 102. Similar to host system 112, a host system 132 of FIG. 1 transmits I/O requests to storage controller 122 for accessing logical volumes. Further, host systems 112 and 132 include Network Interface Controllers (NICs) 114 and 134, respectively. NICs 114 and 134 allow host systems 112 and 132 to communicate with each other over a network 120. Some examples of network 120 include Ethernet, the Internet, IEEE 802.11, etc.

Consider that storage controller 102 is actively managing logical volume 136 and storage controller 122 acts as a backup storage controller for managing logical volume 136. As I/O requests are issued by host system 112 for logical volume 136, storage controller 102 caches data related to the I/O requests in cache memory 110. Cache memory 110 may be operated in a write-through mode or a write-back mode. Over time, more and more data may be cached to cache memory 110. It is desirable that this data in cache memory 110 is replicated at cache memory 130 for use by storage controller 122 in the event that storage controller 102 fails or is otherwise unavailable to manage logical volume 136. Having cache coherency between the storage controller 102 and storage controller 122 allows for storage controller 122 to come up to speed more quickly and efficiently in handling I/O requests for logical volume 136. However, no dedicated high speed communication channel exists between storage controller 102 and storage controller 122 in system 100. Thus, the type of high bandwidth cache mirroring that typically occurs between storage controllers over a dedicated channel is unavailable.

FIG. 2 is a flowchart illustrating a method 200 of maintaining cache coherency between storage controllers utilizing bitmap data in an exemplary embodiment. The steps of method 200 are described with reference to storage system 100 of FIG. 1, but those skilled in the art will appreciate that method 200 may be performed in other systems. The steps of the flowchart(s) described herein are not all inclusive and may include other steps not shown. The steps described herein may also be performed in an alternative order.

In step 202, cache manager 108 of storage controller 102 (see FIG. 1) processes an I/O request from host system 112 for logical volume 136. The request from host system 112 may include a write request for persistently storing data on logical volume 136, a read request for reading data persistently stored on logical volume 136, etc.

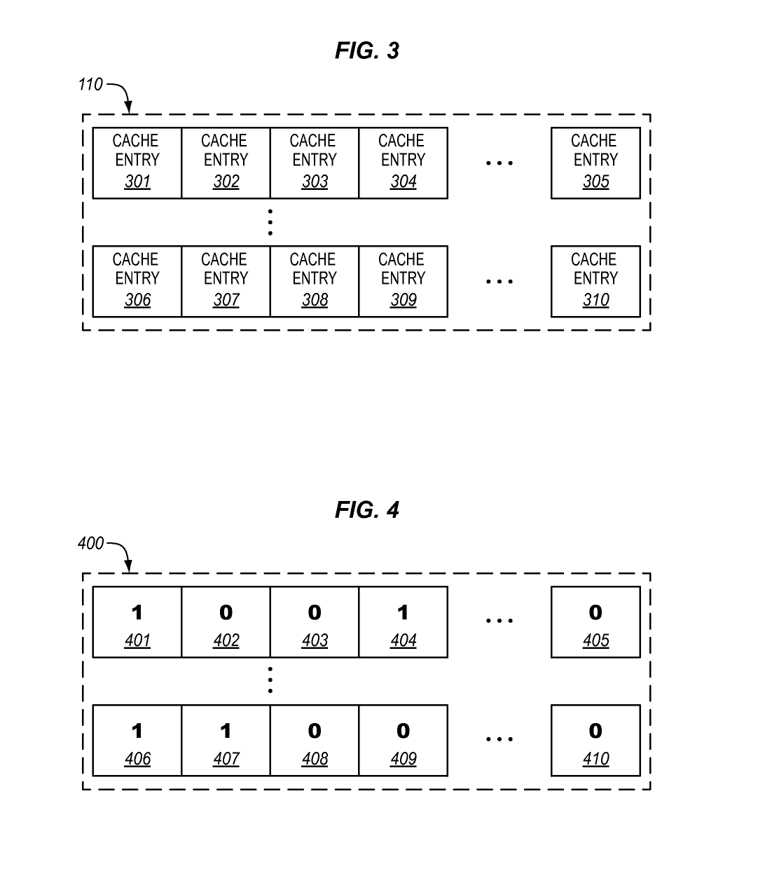

Assuming that the I/O request is a write request, in step 204 cache manager 108 generates one or more entries in cache memory 110 based on the request. During a write request, cache manager 108 may copy the data written to logical volume 136 into cache memory 110 to improve the response time for a subsequent read request for the data. FIG. 3 is a block diagram illustrating a plurality of cache entries 301-310 stored in cache memory 110 in an exemplary embodiment. The amount of data stored by cache entries 301-310 is a matter of design choice. For instance, each of cache entries 301-310 may correspond to a block of data in a Logical Block Addressing (LBA) scheme for storing data at storage devices 118-119, may correspond to a stripe size for a RAID logical volume, etc. Further, the configuration of cache entries 301-310 illustrated in FIG. 3 is just one possible configuration, and other configurations may exist as a matter of design choice.

In step 206, Cache manager 108 identifies a backup storage controller for managing logical volume 136. The backup storage controller may be identified in a number of different ways. For example, an administrator of storage system 100 may specify which controller(s) will operate as backup controllers for logical volume 136. In another example, the registrations for logical volume 136 may be queried. For purposes of discussion, storage controller 122 will be considered as a backup storage controller for managing logical volume 136, although one skilled in the art will recognize that other storage controllers, not shown in FIG. 1, may operate as backup storage controllers for managing logical volume 136.

In step 208, cache manager 108 generates bitmap data that identifies cache entries in cache memory 110 that have changed since synchronizing with storage controller 122. Cache manager 108 may generate this bitmap data periodically, upon some triggering event, etc., as a matter of design choice. FIG. 4 is a block diagram illustrating bitmap data 400 generated by cache manager 108 in an exemplary embodiment. Bitmap data 400 includes a number of bitmap entries 401-410.

In this embodiment, each of bitmap entries 410-410 corresponds with a cache entry of FIG. 3. For instance, bitmap entry 401 corresponds with cache entry 301. In like manner, bitmap entry 410 corresponds with cache entry 310. Bitmap entries 401-410 of bitmap data 400 indicate whether a corresponding cache entry 301-310 has changed since synchronizing with storage controller 122. For instance, after previously synchronizing with storage controller 122, storage controller 102 may receive a number of I/O requests for logical volume 136. Some of the I/O requests may be write requests, which may result in updates to one or more cache entries 301-310 in cache memory 110. However, prior to a new synchronization event with storage controller 122, the changes to cache entries 301-310 are not represented in cache memory 130 of storage controller 122. In this embodiment, a logical 1 in a bitmap entry 401- 410 indicates that a cache entry has changed since a prior synchronization with storage controller 122, and a logical 0 indicates that a cache entry has not changed. However, other options for indicating that a cache entry has changed are possible. In FIG. 4, bitmap entry 401 is a logical 1, indicating that cache entry 301 has changed since a prior synchronization with storage controller 122. Conversely, bitmap entry 402 is a logical 0, indicating that cache entry 302 has not changed since a prior synchronization with storage controller 122.

In step 210, cache manager 108 provides bitmap data 400 to storage controller 122 to allow storage controller 122 to synchronize cache memory 130 with cache memory 110 based on bitmap data 400. For instance, cache manager 108 may forward bitmap data 400 to host system 112, for transmission of bitmap data 400 to network 120 via NIC 114. Host system 132 may then receive bitmap data 400 from network 120 via NIC 134, and provide bitmap data 400 to storage controller 122. Storage controller 122 may perform a synchronization process based on the bitmap data immediately, periodically, and/or based on some triggering event as a matter of design choice. For instance, storage controller 122 may not perform a synchronization process unless storage controller 122 assumes ownership of logical volume 136. In this instance, storage controller 122 may log bitmap changes to cache entries 301-310, and perform a synchronization process by reading logical volume 136 to update the cache entries that have changed. This ensures that cache memory 130 is up-to-date with respect to the data stored by logical volume 136 and with respect to cache entries 301-310 of storage controller 102 relating to logical volume 136.

Utilizing bitmap data 400 allows for cache coherency between storage controller 102 and storage controller 122 to be implemented, which may otherwise not be possible without a dedicated high speed communication channel between storage controllers 102 and 122. Also, the bandwidth costs of bitmap data exchanges over network 120 are minimal, thus preventing the cache synchronization process from overburdening network 120 with traffic.

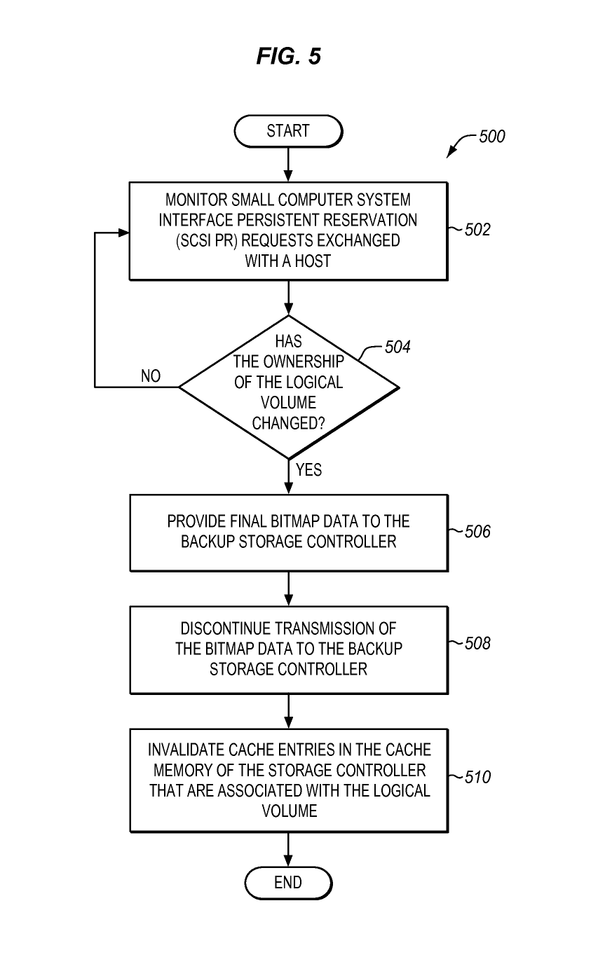

In some cases, an ownership transfer of a logical volume to another storage controller may occur. FIG. 5 is a flowchart illustrating a method 500 of exchanging ownership of a logical volume in an exemplary embodiment. The steps of method 500 are described with reference to storage system 100 of FIG. 1, but those skilled in the art will appreciate that method 500 may be performed in other systems.

In step 502, cache manager 108 monitors Small Computer System Interface Persistent Reservation (SCSI PR) requests exchanged with host system 112. SCSI PR is part of I/O fencing in a clustered storage environment. It enables access for multiple nodes to a storage device coordinate fashion, and may allow access to one node at a time. SCSI PR utilizes the concept of registration and reservation. Each host system may register its own “key” with a storage device. Multiple host systems registering keys form a membership and establish a reservation, typically set to “Write Exclusive Registrants Only” (WERO). The WERO setting enables only registered systems to perform write operations. For a given storage device, only one reservation can exist among numerous registrations. Using SCSI PR, write access for a storage device can be blocked by removing a registration for a storage device. Only registered members can eject the registration of another member. A member wishing to eject another member issues a SCSI PR PREEMPT command to the member to be ejected. An active controller may also issue a SCSI PR RELEASE, followed by backup controller issuing a SCSI PR RESERVE. The backup controller then becomes the active controller for the logical volume, and the previously active controller may become a backup controller for the logical volume.

As cache manager 108 monitors host system 112 for SCSI PR commands, cache manager 108 reviews the command stream exchanged with host system 112 to identify ownership changes for logical volume 136. For instance, cache manager 108 may attempt to find I_T (Initiator_Target) nexus and World Wide Name (WWN) combinations in the command stream that relate to logical volume 136, and monitor SCSI PRs exchanged with host system 112 associated with the combination.

In step 504, cache manager 108 determines if the ownership of logical volume 136 has changed. To determine if the ownership has changed, cache manager 108 may review incoming data to detect a SCSI PR RELEASE and/or SCSI PR PREEMPT commands exchanged with host system 112 for the particular I_T nexus and WWN for logical volume 136. If the ownership has changed, then step 506 is performed. If the ownership of logical volume 136 has not changed, then step 502 is performed and cache manager 108 continues monitoring SCSI PR commands exchanged with host system 112.

In step 506, cache manager 108 begins a process of transferring ownership to a backup storage controller. For purposes of discussion, we will consider that storage controller 122 acts as a backup storage controller for managing logical volume 136. Cache manager 108 of storage controller 102 provides any changes to cache entries 301-310 to storage controller 122 that have not been sent as part of a previous synchronization process. For example, some time may have elapsed between a previous synchronization with storage controller 122 and the determination that the ownership of logical volume 136 is changing. Thus, cache manager 108 may generate some final version of bitmap data 400 reflecting these changes, and provide storage controller 122 with the most up-to-date changes to cache entries 301-310 via bitmap data 400. When backup storage controller 122 assumes ownership of logical volume 136, backup storage controller 122 may then perform a cache synchronization process based on cache entry changes indicated by the bitmap data received by backup storage controller 122.

In step 508, storage controller 102 discontinues transmission of bitmap data 400 to storage controller 122 in response to the ownership change. As the ownership changes for logical volume 136 to storage controller 122, storage controller 122 assumes ownership of logical volume 136 and may begin generating bitmap data for one or more backup storage controllers that identifies changes in cache entries for cache memory 130.

In step 510, storage controller 102, invalidates cache entries 301-310 in cache memory 110 that are associated with logical volume 136. Other cache entries associated with other logical volumes (not shown) may not be affected. For instance, storage controller 102 may manage a number of additional logical volumes, and may therefore continue to generate and provide bitmap data to storage controller(s) that act as backup storage controllers for managing the additional logical volumes.

In some cases, controller 102 may act as a backup storage controller for one or more logical volumes. For instance, subsequent to storage controller 122 obtaining ownership of logical volume 136 from storage controller 102, storage controller 102 may operate as a backup storage controller for logical volume 136. As such, storage controller 102 may receive bitmap data from storage controller 122 that identifies changes to cache entries in cache memory 130 related to logical volume 136. Storage controller 102 may perform a synchronization process to synchronize cache memory 110 of storage controller 102 with cache memory 130 of storage controller 122 based on the changes indicated in the bitmap data. This synchronization process may occur upon storage controller 102 assuming ownership of logical volume 136, thus reducing the amount of I/O processing that storage controller 102 performs while storage controller 102 acts as a backup storage controller for logical volume 136.

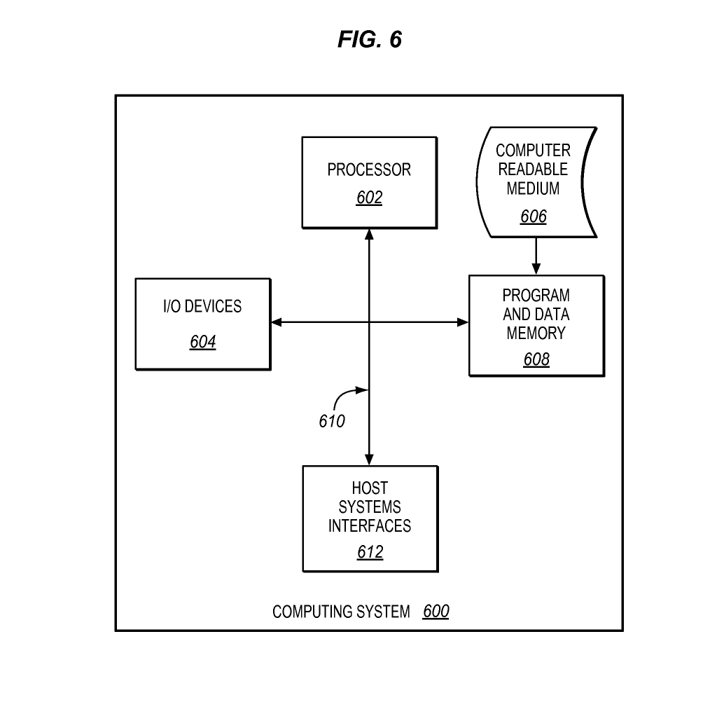

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 6 illustrates a computing system 600 in which a computer readable medium 606 provides instructions for performing any of the methods disclosed herein.

Furthermore, embodiments of the invention can take the form of a computer program product accessible from the computer readable medium 606 providing program code for use by or in connection with a computer or any instruction execution system. For the purposes of this description, the computer readable medium 606 can be any apparatus that can tangibly store the program for use by or in connection with the instruction execution system, apparatus, or device, including the computing system 600.

The medium 606 can be any tangible electronic, magnetic, optical, electromagnetic, infrared, or semiconductor system (or apparatus or device). Examples of a computer readable medium 606 include a semiconductor or solid state memory, magnetic tape, a removable computer diskette, a random access memory (RAM), a read-only memory (ROM), a rigid magnetic disk and an optical disk. Current examples of optical disks include compact disk —read only memory (CD-ROM), compact disk—read/write (CD-R/W) and DVD.

The computing system 600, suitable for storing and/or executing program code, can include one or more processors 602 coupled directly or indirectly to memory 608 through a system bus 610. The memory 608 can include local memory employed during actual execution of the program code, bulk storage, and cache memories which provide temporary storage of at least some program code in order to reduce the number of times code is retrieved from bulk storage during execution. Input/output or I/O devices 604 (including but not limited to keyboards, displays, pointing devices, etc.) can be coupled to the system either directly or through intervening I/O controllers. Network adapters may also be coupled to the system to enable the data processing system to become coupled to other data processing systems, such as through host systems interfaces 612, or remote printers or storage devices through intervening private or public networks. Modems, cable modem and Ethernet cards are just a few of the currently available types of network adapters.

What is claimed is:

1. A system comprising:
a storage controller; and
a backup storage controller;
the storage controller including:
a cache memory; and
a cache manager operable to process an I/O request from a host for a logical volume, and to generate one or more cache entries in the cache memory based on the request;
the cache manager is further operable to identify the backup storage controller for managing the logical volume, to generate bitmap data that identifies cache entries in the cache memory that have changed since synchronizing with the backup storage controller, wherein each bit in the bitmap data identifies whether a corresponding cache entry has changed;
the cache manager further operable to provide the bitmap data to the backup storage controller to allow the backup controller to synchronize a cache memory of the backup storage controller with the cache memory of the storage controller based on the bitmap data.

2. The system of claim 1 wherein:
the storage controller resides within a first host that has a network interface connection to a network;
the backup storage controller resides within a second host that has a network interface connection to the network; and
the cache manager of the storage controller is further operable to provide the bitmap data to the backup storage controller over the network.

3. The system of claim 2 wherein:
the cache manager of the storage controller is further operable to monitor Small Computer System Interface Persistent Reservation (SCSI PR) requests exchanged with the first host, and to determine an ownership change of the logical volume from the storage controller to the backup storage controller based on the SCSI PR requests.

4. The system of claim 3 wherein:
responsive to the storage controller loosing ownership of the logical volume, the cache manager is further operable to discontinue transmission of the bitmap data to the backup storage controller, and to invalidate cache entries in the cache memory of the storage controller that are associated with the logical volume.

5. The system of claim 2 wherein:
a cache manager of the backup storage controller is operable to monitor Small Computer System Interface Persistent Reservation (SCSI PR) requests exchanged with the second host, and to determine an ownership change of the logical volume from the storage controller to the backup storage controller based on the SCSI PR requests.

6. The system of claim 5 wherein:
responsive to the backup storage controller gaining ownership of the logical volume, the cache manager of the backup storage controller is further operable to synchronize the cache memory of the backup storage controller with the cache memory of the storage controller based on the bitmap data.

7. A method operable in a storage system, the method comprising:
processing an Input/Output (I/O) request from a host for a logical volume;
generating one or more cache entries in a cache memory of a storage controller based on the request;
identifying a backup storage controller for managing the logical volume;
generating bitmap data that identifies cache entries in the cache memory that have changed since synchronizing with the backup storage controller, wherein each bit in the bitmap data identifies whether a corresponding cache entry has changed; and
providing the bitmap data to the backup storage controller to allow the backup storage controller to synchronize a cache memory of the backup storage controller with the cache memory of the storage controller based on the bitmap data.

8. The method of claim 7 wherein:
the storage controller resides within a first host that has a network interface connection to a network;
the backup storage controller resides within a second host that has a network interface connection to the network; and
the method further comprises providing the bitmap data to the backup storage controller over the network.

9. The method of claim 8 wherein:
the method further comprises:
monitoring, by the storage controller, Small Computer System Interface Persistent Reservation (SCSI PR) requests exchanged with the first host; and
determining an ownership change of the logical volume from the storage controller to the backup storage controller based on the SCSI PR requests.

10. The method of claim 9 wherein:
responsive to the storage controller loosing ownership of the logical volume, the method further comprises:
discontinuing transmission of the bitmap data to the backup storage controller; and
invalidating cache entries in the cache memory of the storage controller that are associated with the logical volume.

11. The method of claim 8 wherein:
the method further comprises:
monitoring, by the backup storage controller, Small Computer System Interface Persistent Reservation (SCSI PR) requests exchanged with the second host; and
determining an ownership change of the logical volume from the storage controller to the backup storage controller based on the SCSI PR requests.

12. The method of claim 11 wherein:
responsive to the backup storage controller gaining ownership of the logical volume, the method further comprises:
synchronizing the cache memory of the backup storage controller with the cache memory of the storage controller based on the bitmap data.

13. A non-transitory computer readable medium embodying programmed instructions which, when executed by one or more processors, direct the one or more processors to:
process an Input/Output (I/O) request from a host for a logical volume;
generate one or more cache entries in a cache memory of a storage controller based on the request;
identify a backup storage controller for managing the logical volume;
generate bitmap data that identifies cache entries in the cache memory that have changed since synchronizing with the backup storage controller, wherein each bit in the bitmap data identifies whether a corresponding cache entry has changed; and
provide the bitmap data to the backup storage controller to allow the backup storage controller to synchronize a cache memory of the backup storage controller with the cache memory of the storage controller based on the bitmap data.

14. The medium of claim 13 wherein:
the storage controller resides within a first host that has a network interface connection to a network;
the backup storage controller resides within a second host that has a network interface connection to the network; and
the instructions further direct the one or more processors to provide the bitmap data to the backup storage controller over the network.

15. The medium of claim 14 wherein:
the instructions further direct the one or more processors to:
monitor, by the storage controller, Small Computer System Interface Persistent Reservation (SCSI PR) requests exchanged with the first host; and
determine an ownership change of the logical volume from the storage controller to the backup storage controller based on the SCSI PR requests.

16. The medium of claim 15 wherein:
responsive to the storage controller loosing ownership of the logical volume, the instructions further direct the one or more processors to:
discontinue transmission of the bitmap data to the backup storage controller; and
invalidate cache entries in the cache memory of the storage controller that are associated with the logical volume.

17. The method of claim 14 wherein:
the instructions further direct the one or more processors to:
monitor, by the backup storage controller, Small Computer System Interface Persistent Reservation (SCSI PR) requests exchanged with the second host; and
determine an ownership change of the logical volume from the storage controller to the backup storage controller based on the SCSI PR requests.

18. The medium of claim 17 wherein:
responsive to the backup storage controller gaining ownership of the logical volume, the instructions further direct the one or more processors to:
synchronize the cache memory of the backup storage controller with the cache memory of the storage controller based on the bitmap data.
